(19) United States
(12) Patent Application Publication
(10) Pub. No.: US 2004/0162795 A1
(43) Pub. Date: Aug. 19, 2004

(54) Method and system for feature extraction from outgoing messages for use in categorization of incoming messages

(76) Inventors: Jesse Dougherty, North Vancouver (CA); David Ascher, Vancouver (CA)

Correspondence Address: MCANDREWS HELD & MALLOY, LTD, 500 WEST MADISON STREET, SUITE 3400, CHICAGO, IL, 60661

(21) Appl. No.: 10/747,381

(22) Filed: Dec. 29, 2003

Related U.S. Application Data
(60) Provisional application No. 60/436,820, filed on Dec. 30, 2002.

(51) Int. Cl. G06E 1/00; G06E 3/00; G06G 7/00; G06F 15/18

(52) U.S. Cl. 706/20

(57) ABSTRACT

Certain embodiments provide a method and system for dynamic classification of incoming electronic messages in a communication system which includes formulating classification rules for classifying electronic messages according to criteria, extracting feature information from outgoing messages, modifying the classification rules based on the feature information extracted from outgoing messages, and analyzing an incoming message according to the classification rules. The extracting step may also include creating copies of the outgoing messages and extracting feature information from the copies of the outgoing messages. The method may further include classifying the incoming message according to the classification rules. The method may also include routing the incoming message to a destination based on the classification rules.

### RELATED APPLICATIONS

The present application relates to, and claims priority from, U.S. Provisional Application No. 60/436,820 filed on Dec. 30, 2002, and entitled “Feature Extraction from Outgoing Messages for Use in Categorization of Incoming Messages.”

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to electronic message management. In particular, the present invention relates to categorization of incoming messages based on features extracted from outgoing messages.

Organizations, sites within an organization, individuals, and devices often filter, triage, and otherwise process incoming electronic messages, such as electronic mail, instant messages, and short messaging service (SMS) phone messages. Analyzing incoming messages to categorize the incoming messages is a common task performed by electronic message processing systems. Current systems perform categorization by processing incoming messages with classifiers. Classifiers use pre-set rules, or statistically derived rules, based on previously received incoming messages. FIG. 1 illustrates a typical incoming message categorization system 100. Incoming messages received at 110 are processed by a message categorizer 120. The received messages are sorted by category at 130 so that further processing of a message may depend on its category or type of message. A need exists for a system and method for improved analysis and categorization of electronic messages.

For example, message categorizer 120 categorizes an incoming message as legitimate or as unwanted spam. Spam is typically defined as an undesirable, unwanted, or unsolicited message. For example, a mass mailer or “spammer” sends a message advertising a product or service to a plurality of email addresses for users who have not requested the message. Such a message is known as spam. Categorizer 120 searches for obfuscations, random character occurrences, and other data or format commonly used by “spammers,” i.e., senders of unwanted junk email. In addition, categorizer 120 may also examine a message for an indication of forgery.

Processing of outgoing messages in current systems is independent from the processing of incoming messages. As illustrated in FIG. 2, a typical outgoing message processing system 200 includes an outgoing message processor 220. Processor 220 routes messages through basic delivery processing and then transmits the message from the originating organization or site to an intended recipient.

In outgoing message processing system 200, an uncategorized outgoing message is received at 210 by outgoing message processor 220. Processor 220 performs standard processing routines on the outgoing message entered at 210. However, the outgoing message processor 220 does not categorize the outgoing message entering at 210. While the transmitted message at 230 may be processed for delivery to an intended recipient, the transmitted message at 230 is not analyzed and not categorized before delivery.

A lack of characterization of outgoing messages at 230 negatively impacts performance of message categorizer 120 (FIG. 1). Exposing categorizer 120 to an imbalance of spam as opposed to valid electronic messages results in improper characterization of legitimate electronic messages as spam. Messages characterized correctly or incorrectly as spam may be deleted or routed to a junk mail or spam folder or a “trash can” and not read by an intended recipient.

Thus, a system and method for characterizing outgoing messages would be highly desirable. There is a need for an improved electronic message management system and method that dynamically modifies performance of a message classifier based on incoming and outgoing messages.

### BRIEF SUMMARY OF THE INVENTION

The present invention provides a method and system for improved message categorization in a message management system. Certain embodiments of the method include extracting feature information from an outgoing electronic message and analyzing an incoming message based on, at least, the feature information.

In one embodiment, the method includes analyzing an incoming message to determine a presence of a spam feature. The spam feature information may be identified from a previous incoming message that was determined to be undesirable. A set of categorization rules are used to categorize the incoming message. The set of categorization rules may be modified based on feature information extracted from an outgoing electronic message. After categorization, the incoming message is routed to a destination based on the categorization of the message.

Certain embodiments provide a dynamic electronic message categorization system which includes a set of desirable feature information for categorizing a desirable electronic message, a set of undesirable feature information for categorizing an undesirable electronic message, a message categorizer for categorizing an incoming message using the set of desirable feature information and the set of undesirable feature information, and a feature extractor for extracting feature information from an outgoing message. The feature extractor modifies at least one of the set of desirable feature information and the set of undesirable feature information based on the extracted feature information.

In another embodiment, a message categorizer includes a first classifier having a predetermined set of feature information and a second classifier having a dynamic set of feature information dynamically adjustable by a feature extractor. The message categorizer may include a binary classifier analyzing the incoming message using filtering rules formed from at least one of the set of desirable feature information and the set of undesirable feature information. The message categorizer may route the incoming message to a destination based on a categorization. The destination may be a user's inbox or a junk mail folder, for example.

In another embodiment, a feature extractor creates a working copy of the outgoing message from which a feature is extracted. The system may further include a features database including a set of desirable feature information and a set of undesirable feature information. The set of desirable feature information may be dynamically adjusted by feature information extracted from outgoing messages, and the set of undesirable feature information may be dynamically adjusted by feature information extracted from previously received undesirable messages. The feature information may include content, circulation, consent, character set, word patterns, word relationships, and/or word occurrences, for example.

In another embodiment, a method for dynamic classification of incoming electronic messages includes formulating classification rules for classifying electronic messages according to criteria, extracting feature information from outgoing messages, modifying the classification rules based on the feature information extracted from outgoing messages, and analyzing incoming messages according to the classification rules. The extracting step may include creating copies of the outgoing messages and extracting feature information from such copies.

### BRIEF DESCRIPTION OF SEVERAL VIEWS OF THE DRAWINGS

FIG. 1 illustrates an incoming message categorization system for categorizing incoming messages.

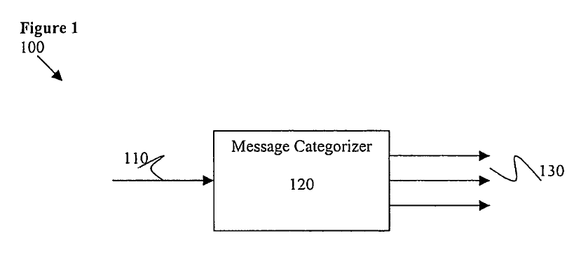

FIG. 2 illustrates an outgoing message processing system for transmitting a message to a recipient.

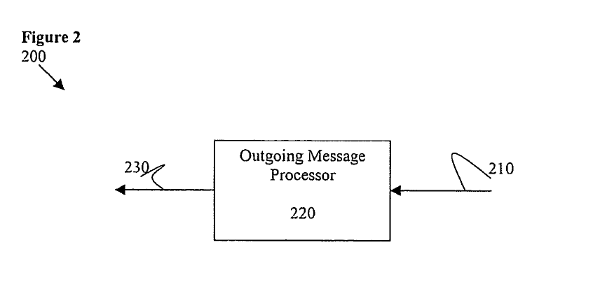

FIG. 3 illustrates an electronic message management system used in accordance with an embodiment of the present invention.

FIG. 4 depicts a flow diagram for a method for classifying electronic messages used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

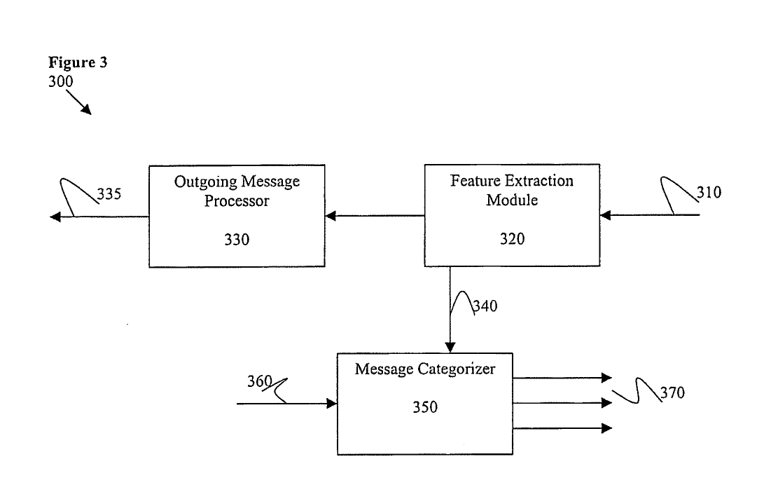

Referring to FIG. 3, an electronic message management system 300 includes a feature extraction module 320, an outgoing message processor 330, and a message categorizer 350. Feature extraction module 320 receives an outgoing message at 310 and analyzes content and other characteristics of the outgoing message. Feature extraction module 320 transmits the analyzed message to outgoing message processor 330 for outgoing message processing, such as processing using conventional outgoing message processing methods. Outgoing message processor 330 routes the processed message at 335 for delivery at a destination.

Feature extraction module 320 generates information which is extracted from an analysis of one or more features of the outgoing message received at 310. The extracted feature information is passed onto the message categorizer 350 as indicated at 340. Categorizer 350 uses the extracted feature information, received at 340, to aid in categorizing an incoming uncategorized message, received at 360. The resulting categorized message is delivered at 370.

The messages at 310, 335, 360 and/or 370 may be single messages or message streams of multiple messages. Messages accommodated by the system 300 may be any of a variety of electronic communications. The messages may be electronic communications delivered via an intermediary server. The messages may be synchronous or asynchronous. The messages, for example, may be Internet email messages, Lotus Notes, AOL mail, CompuServe email, instant messenger communications (e.g., AOL Messenger, MSN Messenger, ICQ), Internet relay chat communications, and/or SMS messages.

Feature extraction module 320 examines the outgoing message which is received at 310 for information that may assist message categorizer 350 in its classification of incoming messages at 360. The features from which information is extracted may include message content (e.g., words, attachments, header information, or other message field information), message circulation (e.g., sender list or recipient list), and/or sender consent (e.g., mailing list membership, “opt in”, or “opt out”). For example, feature extraction module 320 may consider word relationships in a message, word occurrences, or other information in an outgoing message entering at 310. If information associated with a feature or combination of features is identified a certain number of times or in a certain number of messages, for example, then the feature information may indicate that the message is valid, and thus may be used to identify incoming messages at 360 that are probably valid messages as opposed to spam.

Features extracted by feature extraction module 320 may include a plurality of fields or other characteristics of an electronic message. For example, an email address of a recipient (the contents of a “To:” header line, for example) may be analyzed and information extracted. A recipient email address may be used by message categorizer 350 to distinguish valid sender addresses from invalid sender addresses. A way in which a recipient or sender email address is constructed and/or a structure of an attachment to a message may also be analyzed. As another example, features may include an occurrence or non-occurrence of certain words or other data patterns in a message. Statistical properties regarding occurrence of words or other data patterns, such as a number of feature information occurrences or a percentage of feature information matches, may also be determined. As another example, feature extraction module 320 may also extract message routing information, such as header information, from the outgoing message received at 310. Semantic information, such as information in a message header (the information in a “Subject:” header, for example) or in a message body, may also be extracted. Feature extraction module 320 may also determine qualitative information, such as message size, and/or contextual information, such as a time at which a message is sent and/or the existence of a “thread context” (i.e., was an incoming message sent in response to a previously sent outgoing message), for example.

In an embodiment, feature extraction module 320 analyzes the outgoing message received at 310 as a document, and attempts to identify document features that will assist message categorizer 350 in classifying an incoming message at 360. Feature extraction module 320 operates on an assumption that information regarding a valid message may be found in the outgoing messages received at 310 because the message at 310 originates within an organization or specific department or site serviced by the message management system 300.

For example, the feature extraction module 320 may generate feature information by splitting the outgoing message received at 310 into a collection of words (separating by whitespace, for example). The set of words is used to “train” message categorizer 350, such as a naive bayes classifier, as to words which are indicative of non-spam features. When a new message arrives at 360, the message is then classified to determine if the message is spam or not spam. Alternatively, feature information may be extracted by the feature extraction module 320 related to a specific department or site within an organization and applied only to incoming messages received at 360 which are addressed to an entity within the specific department or site.

In another embodiment, feature extraction module 320 extracts character sets used in the outgoing message received at 310, for example, Chinese characters. The character sets may be used to determine whether an incoming message at 360 is composed using a proper character set for the receiving entity. The message may be converted to an acceptable character set for the recipient(s) of the incoming message at 360.

In an embodiment, feature extraction module 320 processes outgoing message(s) received at 310 in real time as the message at 310 is in route being transmitted from a sender to a recipient. Features of the message received at 310 are extracted before the message is transmitted via outgoing message processor 330 to the recipient.

In an alternative embodiment, the outgoing message received at 310 and/or feature information extracted from the outgoing message received at 310 may be copied by module 320, and the outgoing message is released to processor 330 for transmission. The copy may be stored in a message folder, an external memory, or a memory internal to module 320 or to categorizer 350. Feature extraction module 320 processes the copy of the outgoing message received at 310 while the outgoing message is transmitted at 335 and delivered to an intended recipient.

The feature information extracted by module 320 is transferred to message categorizer 350, as indicated at 340. The feature information may be stored in a features database or other memory for use by message categorizer 350. The feature information may be combined to form categorization or filtering rules and/or used individually by categorizer 350. Additionally, a portion of the feature information extracted from an outgoing message may be used by the categorizer 350. Threshold values may be associated (by module 320 or categorizer 350, for example) with certain features or combinations of features. For example, certain feature information associated with a threshold must be found less than a certain number of times or greater than a certain number of times in an incoming message in order to trigger a certain categorization of the message.

Message categorizer 350 categorizes or examines incoming messages which are received at 360 in order to deliver valid messages to a recipient and to block or redirect unwanted messages. For example, incoming messages at 360 from senders to which outgoing messages at 310 have been sent are allowed to reach intended recipients at 370. In an embodiment, message categorizer 350 includes a simple rule-based classifier to classify an incoming message received at 360. Alternatively, categorizer 350 may include a statistical system, a complex rule-based system (e.g., Procmail, SpamAssassin), an adaptive system, a non-adaptive system, a distributed system, and/or a centralized system, for example.

Message categorizer 350 may be a binary classifier, naive bayes classifier, document classifier, or any other message or feature categorization system, for example. With a binary classifier, a message is examined to determine whether certain feature information is present in the message. The binary classifier returns a 1 or 0 indicating presence or absence of the feature information. In an embodiment, message categorizer 350 includes a two-level classifier. A first level includes a fixed level of message feature information independent of prior message characteristics. For example, the first level includes a predetermined set of feature information or classification rules used to categorize electronic messages. A second level dynamically forms and adjusts new feature information sets or classification rules based on previously analyzed messages and extracted feature information. In an embodiment, the first level classifier may be modified such that a strength or weight assigned to certain feature information may be adjusted based on previously viewed messages.

In an embodiment, feature extraction module 320 and/or message categorizer 350 includes a counter associated with certain feature information extracted from outgoing messages received at 310. Message categorizer 350 counts a number of occurrences of one or more pieces of feature information in an incoming message received at 360. Counters may be associated with both spam and non-spam feature information. For example, if a number of occurrences of a piece of a non-spam feature information in the message received at 360 is greater than a threshold, then message categorizer 350 classifies the message as non-spam. Additionally, for example, if a number of occurrences of a piece of spam feature information is greater than a threshold, then message categorizer 350 classifies the message as spam. Alternatively, for example, if a number of occurrences of a piece of non-spam feature information is less than a threshold, then message categorizer 350 categorizes the message received at 360 as spam.

In an embodiment, message categorizer 350 performs a “whitelisting” categorization. That is, messages received at 360 from senders to which outgoing messages have been sent are accepted and delivered to recipients. Spam or undesirable messages may be added to a “black list” or “junk mail list,” for example. Alternatively, categorizer 350 may categorize the incoming message received at 360 based on the desirability of the message (offensive, illegal, against corporate policy, for example), semantic analysis (for example, related to a particular project, personal vs. work-related, level of urgency), routing and filtering (for example, should be bounced/dropped/quarantined/passed, etc., or should go to a pager, IM account, email, or particular folder).

The categorized message is transmitted at 370 to a destination. The destination depends upon the classification of the message. For example, if the message is classified as a legitimate or wanted message, the message is delivered at 370 to one or more intended recipients. For example, the message may be routed at 370 to a recipient's inbox or to one of several different message folders. If the message transmitted at 370 is classified as an unwanted or spam message, for example, the message may be deleted or routed to a “junk mail” or “trash can” electronic folder at 370. The folder destination at 370 may be associated with an intended recipient or may be a general-use system folder for spam. The message transmitted at 370 may be routed for further processing prior to delivery. For example, the message may be routed at 370 for sorting among message folders and/or for virus checking.

A user may review messages categorized as unwanted messages by message categorizer 350 by reviewing a junk mail folder, for example. The user may then confirm the categorization to message categorizer 350 or inform message categorizer 350 that a message is a valid message rather than spam. For example, a graphical user interface, such as a Microsoft Windows®-compatible program, may be installed on a user's computer and allow the user or an administrator to adjust settings of module 320 and/or categorizer 350. Alternatively, an interface with the categorizer 350 and/or module 320 may be integrated into a user's electronic mail software. The user may confirm or change the categorization of a message by electronic selection or rejection of options or entries, for example. Notification of an incorrect message categorization by the categorizer 350 may result in adjustment by an administrator and/or categorizer 350 of feature weight or classification rule structure in module 320 and/or categorizer 350. Thus, message categorizer 350 may improve its classification ability.

System 300 may be implemented on a single computer system for processing incoming and outgoing messages. Alternatively, components of system 300 may be implemented in a distributed network where different processes occur on different machines with a communication network to allow sharing of information. System 300 may be implemented using one or more software programs.

In operation, for example, message categorizer 350 is initialized with spam messages and non-spam messages. For example, spam messages are supplied to message categorizer 350 by a system administrator. An outgoing message entered at 310 may be used to provide non-spam feature information to categorizer 350.

Then, a user composes an electronic mail message using an email program, such as Microsoft Outlook® or Hotmail®. The electronic mail message is transmitted from the user's computer to a mail server, such as electronic message management system 300. The electronic mail message enters at 310 to feature extraction module 320. Feature extraction module 320 extracts feature information, such as words, fields, and/or characteristics, from the outgoing electronic mail message. Alternatively, feature extraction module 320 may make a copy of the outgoing message or of feature information extracted from the message. Feature extraction module 320 instead may merely examine a copy of the outgoing message saved in a “sent mail” folder of a user's message composition program.

The message feature information is transmitted via an information transfer at 340 to message categorizer 350. Feature information may be stored at message categorizer 350 or stored at another storage device. Features may be stored in a database or text file, for example. The feature information is used by message categorizer 350 to classify valid or desirable messages versus unwanted or spam messages.

After feature extraction, feature extraction module 320 transmits the outgoing message received at 310 to outgoing message processor 330. Outgoing message processor 330 prepares the message for delivery and, at 335, routes the message to a mail server for delivery to one or more intended recipients. The message routed at 335 may then be viewed by the recipient(s).

When an uncategorized incoming message arrives at message management system 300, the uncategorized incoming message is received at 360 by message categorizer 350. Message categorizer 350 categorizes or classifies the incoming message received at 360. The message is categorized as a wanted or unwanted message. Categorizer 350 classifies the message received at 360 according to feature information extracted from known valid messages, such as the outgoing messages received at 310. Message categorizer 350 determines a presence of extracted feature information in the incoming message. That is, message categorizer 350 compares the message received at 360 with feature information extracted from outgoing messages received at 310. If feature information in the incoming message matches feature information stored in message categorizer 350, then the message received at 360 is classified as a wanted message. However, if less than a certain threshold of feature information stored in message categorizer 350 are found in the message received at 360, then message categorizer 350 categorizes the incoming message as an unwanted message. In an embodiment, the incoming message may be classified by determining the presence of all or part of the extracted feature information in the message.

After message categorizer 350 has categorized the incoming message received at 360, the categorized message is routed at 370 to an appropriate destination. If the message routed at 370 is classified as a valid message, the message is delivered to an intended recipient or routed for further processing, such as sorting and/or virus scanning, before delivery. For example, the message may be delivered to an electronic “inbox” for an intended recipient. If the message is classified as spam or an invalid message, the message is delivered to an alternate location, such as a recipient's junk mail or spam electronic folder or electronic “trash can.” Alternatively, spam messages may be deleted at 370.

In an embodiment, an outgoing message received at 310 or a copy of the outgoing message is processed according to message classification rules in the message categorizer 350 to further train message categorizer 350 and/or feature extractor 320. If a valid outgoing message is improperly classified as spam by a spam classification rule or blacklist item of the message categorizer 350, then the processing/categorizing rules of message categorizer 350 may be automatically (e.g., by software) or manually (e.g., by a user) adjusted to reduce a likelihood of improperly categorizing a valid message as spam. For example, categorizing rules based on extracted feature information may be assigned a priority level. That is, certain feature information may have a higher priority, and thus a higher impact on message classification, than other feature information. If a spam rule is improperly satisfied by one or more valid outgoing message at 310, the priority of the rule may be reduced or eliminated. If a spam classification rule includes several features, occurrence of one or more pieces of the feature information in an outgoing message at 310 may result in adjustment of the rule. Operation of feature extraction module 320 may also be adjusted based on incorrect classification to reduce likelihood of incorrect feature extraction and analysis.

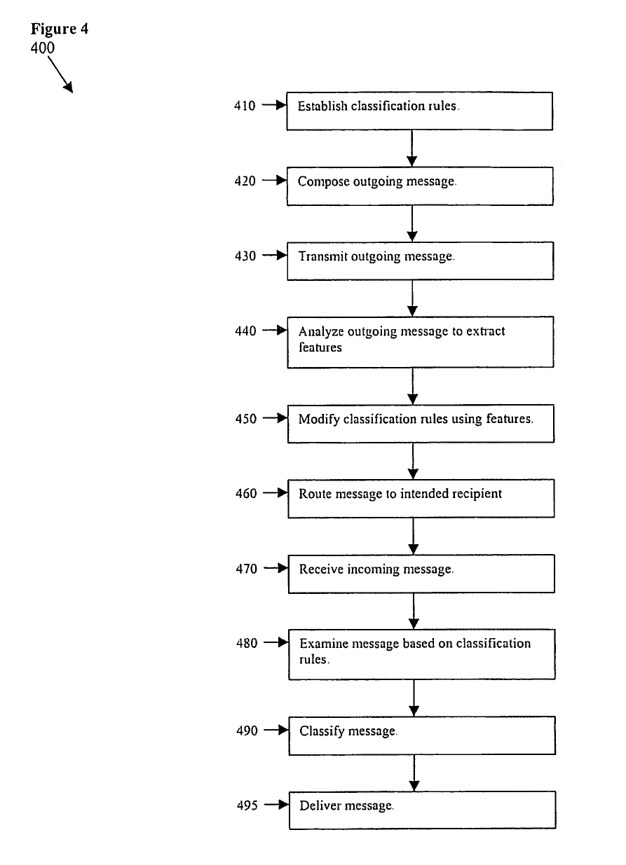

FIG. 4 depicts a flow diagram for a method 400 for classifying electronic messages used in accordance with an embodiment of the present invention. First, at step 410, classification rules are established to categorize valid and invalid messages in a communications system 300. The classification rules are stored in or associated with message categorizer 350. At step 420, an outgoing message is composed. For example, a user drafts an email message using a web browser. Then, at step 430, the outgoing message is transmitted and enters at 310. For example, the user initiates sending of the message to intended recipient(s).

Next, at step 440, the outgoing message received at 310 is analyzed by feature extraction module 320 in order to extract feature information from the message. That is, the outgoing message received at 310 is examined to identify feature information characteristic of a legitimate email message of the user and/or the user's organization. For example, content, recipients, word occurrences, word patterns, and other message features may be identified in the message by feature extraction module 320.

At step 450, the extracted features are used to modify the classification rules used by the message categorizer 350. For example, word occurrences and word patterns found in the message received at 310 may increase a weight associated with a non-spam classification rule in message categorizer 350. Conversely, detection of content associated with a spam classification rule in the message received at 310 may decrease a weight associated with the spam classification rule. In another embodiment, feature information may be divided into a set of desirable feature information and a set of undesirable feature information. The sets of feature information may be dynamically modifiable by feature extraction and/or message classification and may be used to classify a message received at 360 as a desirable or undesirable message. Then, at step 460, the message is processed by outgoing processor 330 and then routed at 335 to the intended recipient(s).

At step 470, an incoming message at 360 is received by system 300. Next, at step 480, the message received at 360 is examined by message categorizer 350 to compare contents of the message to the classification rules of the categorizer 350. For example, the message received at 360 is searched for certain word occurrences or patterns indicative of a valid message based on messages previously sent from the user or the user's system. Then, at step 490, the message received at 360 is classified as a desirable or undesirable message by message categorizer 350. For example, if certain non-spam classification rules are met, such as certain features are found in the message received at 360, then the message is classified as a valid, non-spam message. Finally, at step 495, the categorized message is delivered at 370 to the intended recipient(s). In an embodiment, the categorized message is delivered at 370 to a message folder at the recipient(s) based on the categorization of the message. The message delivered at 335 may be further processed to check for viruses and may be routed to a certain folder defined by a recipient based on message content (e.g., based on sender and/or subject).

Thus, certain embodiments of the present invention provide a system and method for classifying incoming messages at a site based on outgoing messages from a user at the site. Certain embodiments use information from outgoing messages to “train” a message categorizer to distinguish valid messages from spam. If data is found in an outgoing message, an impact of the data is adjusted in a message classifier. That is, if a certain characteristic or content is found in more than a certain threshold of outgoing messages or more than a certain number of times within an outgoing message, then the message classifier modifies a weight given to the feature information when categorizing incoming messages.

Certain embodiments reinforce a non-spam classification in order to counterbalance a spam classification to more accurately determine whether an incoming message is spam or non-spam. Certain embodiments provide a system and method that are dynamically adjusted based on feature information for both outgoing and incoming messages to identify spam and non-spam messages.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for improved classification of electronic messages, said method comprising:
extracting information associated with at least one feature from an outgoing electronic message transmitted from a site; and
analyzing an incoming message received at said site to determine a presence of said information associated with said at least one feature in said incoming message.

2. The method of claim 1, and further comprising analyzing said incoming message to determine a presence of spam feature information in said incoming message, said spam feature information identified from a previous incoming message determined to be undesirable.

3. The method of claim 1, and further comprising storing said information associated with said at least one feature in a features database for use in analyzing said incoming message.

4. The method of claim 1, and further comprising creating a set of categorization rules for categorizing said incoming message.

5. The method of claim 4, and further comprising modifying said set of categorization rules based on said information associated with said at least one feature extracted from said outgoing electronic message.

6. The method of claim 1, and further comprising categorizing said incoming message based on said information associated with said at least one feature.

7. The method of claim 6, and further comprising routing said incoming message to a destination based on said categorizing step.

8. A method for dynamic classification of incoming electronic messages in a communication system, said method comprising:
formulating classification rules for classifying electronic messages;
extracting feature information from outgoing messages;
modifying said classification rules based on said feature information extracted from outgoing messages; and
analyzing an incoming message according to said classification rules.

9. The method of claim 8, and further comprising classifying said incoming message according to said classification rules.

10. The method of claim 8, and further comprising routing said incoming message to a destination based on said classification rules.

11. The method of claim 8, and further comprising modifying said classification rules based on feature information extracted from an undesirable message.

12. The method of claim 8, and further comprising modifying said classification rules based on feature information extracted from a desirable message.

13. The method of claim 8, wherein said extracting step further comprises:
creating copies of said outgoing messages; and
extracting feature information from said copies of said outgoing messages.

14. A dynamic electronic message categorization system, said system comprising:
a set of desirable feature information for categorizing a desirable electronic message;
a set of undesirable feature information for categorizing an undesirable electronic message;
a message categorizer for categorizing an incoming message using said set of desirable feature information and said set of undesirable feature information; and
a feature extractor for extracting feature information from an outgoing message, said feature extractor modifying at least one of said set of desirable feature information and said set of undesirable feature information based on said extracted feature information.

15. The system of claim 14, wherein said message categorizer further comprises a first classifier including a predetermined set of feature information and a second classifier including a dynamic set of feature information dynamically adjustable by said feature extractor.

16. The system of claim 14, wherein said message categorizer further comprises a binary classifier analyzing said incoming message using classification rules formed from at least one of said set of desirable feature information and said set of undesirable feature information.

17. The system of claim 14, wherein said message categorizer routes said incoming message to a destination based on a categorization.

18. The system of claim 14, wherein said feature extractor creates a copy of said outgoing message to extract feature information from said copy of said outgoing message.

19. The system of claim 14, and further comprising a features database including said set of desirable feature information and said set of undesirable feature information.

20. The system of claim 14, wherein said set of desirable feature information is dynamically adjusted by feature information extracted from outgoing messages, and wherein said set of undesirable feature information is dynamically adjusted by feature information extracted from previously received undesirable messages.

21. The system of claim 14, wherein said feature information further comprises information regarding at least one of content, circulation, consent, character set, word patterns, word relationships, and word occurrences.
